(19) United States
(12) Patent Application Publication
(10) Pub. No.: US 2024/0302319 A1
(43) Pub. Date: Sep. 12, 2024

(54) DESIGN FOR SUPPRESSING ARTIFACTS IN CONCURRENT VOLTAMMETRY AND ELECTROPHYSIOLOGICAL RECORDING

(71) Applicant: TRUSTEES OF DARTMOUTH COLLEGE, Hanover, NH (US)

(72) Inventors: Hui Fang, Hanover, NH (US); Yi Qiang, West Lebanon, NH (US); Yongli Qi, Hanover, NH (US)

(21) Appl. No.: 18/601,999

(22) Filed: Mar. 11, 2024

Related U.S. Application Data
(60) Provisional application No. 63/451,213, filed on Mar. 9, 2023.

(51) Int. Cl. G01N 27/327; G01N 27/30

(52) U.S. Cl. CPC G01N 27/3277; G01N 27/307; G01N 27/308

(57) ABSTRACT

A probe includes a fast-scanning cyclic voltammetry electrode, a conductive wall disposed around the fast-scanning cyclic voltammetry electrode, and a wire in electronic communication with the fast-scanning cyclic voltammetry electrode. The conductive wall is grounded. Fast scanning cyclic voltammetry electrode currents are enclosed within the conductive wall. Resulting fast scanning cyclic voltammetry can have sub-μV level artifacts.

### CROSS-REFERENCE TO RELATED APPLICATIONS

This application claims priority to the provisional patent application filed Mar. 9, 2023 and assigned U.S. application Ser. No. 63/451,213, the disclosure of which is hereby incorporated by reference.

### FIELD OF THE DISCLOSURE

This disclosure relates to electrodes for electrophysiological recording.

### BACKGROUND OF THE DISCLOSURE

Fast-scanning cyclic voltammetry (FSCV) is an electroanalytical technique that can provide rapid acquisition of a voltammogram within several milliseconds with high temporal resolution. This technique can be used to monitor release and uptake dynamics of chemical both in vitro and in vivo. Fast scan cyclic voltammetry can measure, for example, dopamine (DA), serotonin (5-HT), and norepinephrine (NE), because these substances can be oxidized at low voltages, which provides selective electrochemical detection based on voltage-dependent oxidation and reduction processes.

In FSCV, a small electrode (e.g., micrometer scale) is inserted into living cells, tissue, or extracellular space. The electrode is used to quickly raise and lower the voltage in a triangular wave fashion. When the voltage is in the correct range (e.g., ±1 Volt), the compound of interest will be repeatedly oxidized and reduced. This will result in a movement of electrons in solution that will create a small alternating current, such as on the nano amps scale. By subtracting the background current created by the probe from the resulting current, a voltage-versus-current plot unique to each compound can be generated. Since the time scale of the voltage oscillations is known, this can then be used to calculate a plot of the current in solution as a function of time. The relative concentrations of the compound may be calculated if the number of electrons transferred in each oxidation and reduction reaction is known.

Due to the volume conduction of the currents induced by the applied voltage in the FSCV electrodes in conductive brain tissue, FSCV typically induces mV-level artifacts in nearby electrical recordings during the scan cycles with lasting rippling effects as the FSCV current propagates, therefore confounding both spike and local field potential (LFP) recordings (and their real-time viewing during experiments). FSCV-induced artifacts continue to be a problem that complicates adoption of FSCV. Previous techniques cannot effectively reduce or eliminate the FSCV-induced artifacts from the device design stage. Offline spectral interpolation approaches were used to reduce the artifacts that, to a certain degree, removed the main voltage artifacts. However, the longer-term spatiotemporal effect on LFPs is not addressed and can be difficult to eliminate using signal processing approaches because it is dependent on biology. It also is unknown what FSCV current is doing to the surrounding cells and neuronal circuits. Eliminating the artifacts from front-end neural probes may be preferred to keep a higher fidelity of recorded neural data, especially to keep the synchronized electrical and neurotransmitter signals.

Therefore, improved techniques and systems are needed.

### BRIEF SUMMARY OF THE DISCLOSURE

A system is disclosed in a first embodiment. The system includes a probe; a fast-scanning cyclic voltammetry electrode disposed on the probe; a conductive wall disposed around the fast-scanning cyclic voltammetry electrode; and a wire in electronic communication with the fast-scanning cyclic voltammetry electrode. The conductive wall and wire are disposed on the probe. The conductive wall is grounded and is disposed on the probe.

Fast scanning cyclic voltammetry electrode currents can be enclosed within the conductive wall.

The conductive wall may have a height from 1 μm to 100 μm and may define a gap between the conductive wall and an area of the fast-scanning cyclic voltammetry electrode from 0.1 μm to 1000μ. In an instance, the height is from 1 μm to 10μ. In an instance, the gap is from 1 μm to 20 μm.

The fast-scanning cyclic voltammetry electrode may be fabricated of Ti/Au.

The system can include a carbon coating disposed on the fast-scanning cyclic voltammetry electrode.

The conductive wall can be disposed on an insulator layer that extends around the fast-scanning cyclic voltammetry electrode. The insulator layer can include photoresist, silicon dioxide, or silicon nitride. For example, the wire can extend through the insulator layer or under the insulator layer.

The conductive wall may be fabricated of a material that includes gold, platinum, silver, AgCl, IrOₓ, or PEDOT:PSS.

The conductive wall may extend upward from a surface of the probe to fully encircle the fast-scanning cyclic voltammetry electrode. The fast-scanning cyclic voltammetry electrode can be exposed through an aperture in a center of the conductive wall.

A method is disclosed in a second embodiment. The method includes performing a neural electroanalytical technique (e.g., fast scanning cyclic voltammetry) using a probe with an electrode and a conductive wall disposed around the electrode. The conductive wall is connected to ground.

Electrode currents can be enclosed within the conductive wall.

The electroanalytical technique may be fast scanning cyclic voltammetry, squarewave voltammetry, or differential pulse voltammetry.

The electroanalytical technique can be fast scanning cyclic voltammetry. In an instance, the fast-scanning cyclic voltammetry may be configured to have less than 180 μVp-p. In another instance, the fast-scanning cyclic voltammetry is configured to have sub-μV level artifacts using the electrode. In another instance, the fast-scanning cyclic voltammetry is configured to be artifact-free using the electrode.

The conductive wall may be fabricated of a material that includes gold, platinum, silver, AgCl, IrOx, or PEDOT:PSS.

### DESCRIPTION OF THE DRAWINGS

For a fuller understanding of the nature and objects of the disclosure, reference should be made to the following detailed description taken in conjunction with the accompanying drawings, in which:

FIG. 1 is a cross-sectional view that shows an embodiment of the 3D reference/ground concept in accordance with the present disclosure;

FIG. 2 shows a Finite Element Analysis (FEA) simulation showing FSCV current density plots with and without the wall ground design;

FIG. 3 shows a microscope image of the hybrid probe with preliminary local reference/ground design in accordance with the present disclosure, as magnified in the inset of FIG. 4;

FIG. 5 is a SEM image of the formed Au-wall reference/ground;

FIG. 6 is the FSCV artifact suppressing result from the preliminary Au-wall reference/ground design in accordance with the present disclosure, wherein the voltage scan window is from −0.4 to 0.4 V;

FIG. 7 shows a SEM image of another formed Au-wall ground around a microelectrode;

FIG. 8 is a microscope image of an ephys-FSCV microelectrode array (MEA) probe with preliminary Au/PEDOT:PSS conductive wall ground in accordance with the present disclosure;

FIG. 9 is an FSCV artifact prevention result from PBS bench testing on a probe similar to that of FIG. 8; and

FIG. 10 shows in vivo FSCV artifact result (rat brain, conductive wall at 7 mm depth) at ephys ch3 of a probe similar to that of FIG. 8, wherein the shaded areas highlight the time windows of one FSCV scan, and wherein the FSCV voltage window is −0.4 to 0.6V because there is no carbon.

### DETAILED DESCRIPTION OF THE DISCLOSURE

Although claimed subject matter will be described in terms of certain embodiments, other embodiments, including embodiments that do not provide all of the benefits and features set forth herein, are also within the scope of this disclosure. Various structural, logical, process step, and electronic changes may be made without departing from the scope of the disclosure. Accordingly, the scope of the disclosure is defined only by reference to the appended claims.

Embodiments disclosed herein provides fewer FSCV-induced artifacts during simultaneous electrophysiology recording and neurochemical sensing, which is currently not performed with brain activity mapping. Currently, the gold standard electroanalytical method of neurochemical measurements is FSCV because of its combination of fast temporal resolution, high sensitivity, analyte selectivity, and its ability to detect and differentiate a variety of neurochemicals, including dopamine (DA), serotonin (5-HT), epinephrine (Epi), and adenosine (Ado). FSCV also has been used in humans to measure sub-second DA fluctuations in nanomole levels. However, the large voltage window, fast scan rate (typically 400 V/s), and frequency (typically 10 Hz) tend to create unwanted artifacts that interfere the potential of recording electrodes nearby. FSCV-induced artifacts are usually orders of magnitude larger than the recorded neural signals, which can contaminate the recording and make concurrent measurements difficult. Thus, a 3D reference/ground structure surrounding the FSCV electrodes can suppress the FSCV-induced artifacts. Preliminary experimental data of the embodiments disclosed herein shows the artifacts decreased from approximately 5 mV to approximately 100μ V level with the 3D reference/ground design. Modeling results indicate that this concept can provide better artifact-reduction effect.

The 3D reference/ground design can be configured to have sub-μV level artifacts or achieve artifact-free multi-functional neural probes for concurrent electrophysiology and neurochemical sensing. The artifact prevention can ensure that the electrical signals are clean and can be analyzed or interpreted. The multi-functional neural probe that measures both neural electrical signals and neurotransmitters can facilitate relevant neuroscience research and clinical applications.

Furthermore, by optimizing the fabrication process, the 3D reference/ground structure can be maintained in a brain chronically. Maintaining the 3D reference/ground structure in the brain chronically can be enabled by factors such as the dimension of the structures, the adhesion of their materials, and/or their biocompatibility.

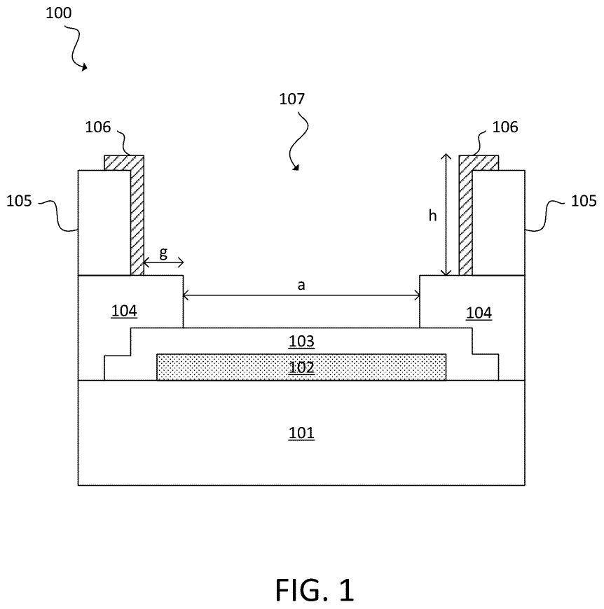

FIG. 1 shows an embodiment of the 3D reference/ground concept in a probe 100. The probe 100 includes a base 101, which can be Kapton or other materials. An FSCV electrode 102 is disposed on the base 101. The FSCV electrode 102 can be, for example, Ti/Au. An optional layer of carbon 103 is disposed over the FSCV electrode 102. A first insulator layer 104 and second insulator layer 105 are disposed on the base 101 and/or the layer of carbon 103.

A conductive wall 106 is disposed on the first insulator layer 104 and/or second insulator layer 105. The conductive wall 106 can be connected to ground or another voltage. The conductive wall 106 is shown extending over the top of the second insulator layer 105 in FIG. 1, but the conductive wall 106 may be the same height as the second insulator layer 105. While the first insulator layer 104 and second insulator layer 105 are shown as separate components, the first insulator layer 104 and second insulator layer 105 may be made as one integral component.

The conductive wall 106 forms an aperture 107 in a center of the conductive wall 106 as the conductive wall 106 extends upward from the base 101. The conductive wall 106 can fully encircle the FSCV electrode 102. The FSCV electrode 102 (or the optional layer of carbon 103 over the FSCV electrode 102) can be exposed through the aperture 107. The dimension a in FIG. 1 represents the width of the FSCV electrode 102 that is exposed. The dimension a may be less than a dimension of the aperture 107 between the conductive wall 106. In FIG. 1, dimension h represents a height of the conductive wall 106. Dimension g represents a gap between the dimension a and an edge of the conductive wall 106. Two of the gap g and the dimension a can represent the dimension of the aperture 107.

While disclosed with FSCV techniques, the embodiments disclosed herein also can be applied to other techniques such as squarewave voltammetry or differential pulse voltammetry.

The following examples are included with this description. The examples are not meant to be limiting.

### Example 1

FSCV-induced voltage artifacts are a problem when conducting FSCV and electrical recording simultaneously. These artifacts are generated from the volume conduction of the currents induced by the applied voltage in the FSCV electrodes in the conductive brain tissue around the ephys recording sites. The voltage artifacts observed from the ephys sites are typically periodic, consistent with the applied FSCV voltage scans (usually at 10 Hz). The main FSCV artifacts generally occur during the voltage scan. For example, assuming a double sweep between-0.4 V to 1.1 V at a 400 V/s rate, the artifact in each cycle will last for 7.5 ms for the main peak but will have longer-term effects at different recording sites as the FSCV current propagates. This confounds both spike and local field potential (LFP) recordings. There has been development of offline spectral interpolation approaches to reduce the artifacts, which to a certain degree, removed the main voltage artifacts. However, the longer-term spatiotemporal effect on LFPs is not dealt with and is difficult to eliminate using signal processing approaches because it is dependent on biology. It is also unknown what the FSCV current is doing to the surrounding cells and neuronal circuits.

By enclosing the FSCV currents physically within the volume defined by the FSCV and reference/ground electrodes, the FSCV-induced artifacts can be reduced. Preliminary simulation and experimental results of an embodiment of FIG. 1 both show this effect. With microfabrication and nanofabrication, local reference/ground is achievable, and specifications of a 3D reference/ground walls to enclose the FSCV currents can provide further optimization.

The electrode can be tethered using a wire that extends through or under the conductive wall (e.g., gold). The wire can be fabricated of a metal or metal alloy in the form of a thin film. While the current produced by the electrode is enclosed, there may be gaps in the conductive wall around the electrode. A continuous conductive wall may provide improved results, but a wall with gaps may still provide the desired operation. The conductive wall disclosed herein is illustrated as square, but also can be circular, ovoid, rectangular, polygonal, or other shapes. The electrode can be in electrical communication with a wire, integral with the wire, or at an end of the wire. This wire can provide current to the electrode.

The probe may include other electrodes used for electrical recording. These other electrodes may not be enclosed with the conductive wall.

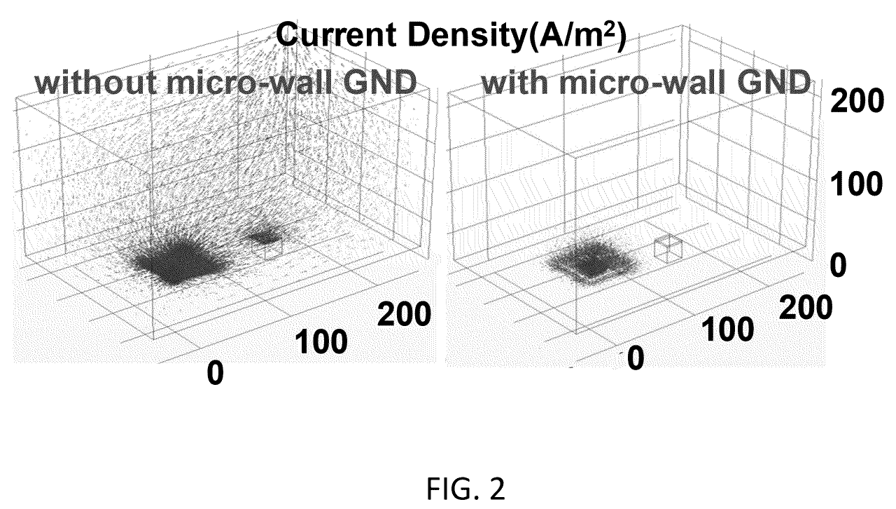

FEA with a volume conduction model was performed to simulate the FSCV artifact and investigate the effects of this design with different reference/ground height (h), gap (g), impedance (Z_{ref}), and dimension (a) of the FSCV electrode as shown in FIG. 1. In an example, the dimension (a) in each direction results in an area for the FSCV electrode from 1 μm² to 1 mm². The FSCV electrode may be fabricated of Ti/Au and can include a carbon coating. Preliminary FEA results in FIG. 2 demonstrate how the FSCV capacitive current conducts in the volume with and without the conductive wall ground design. Assuming FSCV generates an approximately 0.5 A/cm² peak current density into the recording environment, the simulated potential at the ephys electrode (100 μm away from the FSCV electrode) decreased from 1.7 mVₚ₋ₚ to approximately 8 μVₚ₋ₚ (2.8μ Vᵣₘₛ) with a gold (Au) reference/ground wall (h=5μ, g=10μ). Such a wall can be manufactured using microfabrication techniques.

While specific values are disclosed, the height (h) can be from 1 μm to 100 μm. If the 3D wall is less than 1 μm then artifact suppression may not be effective. If the 3D wall is more than 100 μm then sensitivity of the electrode can be affected.

While specific values are disclosed, the gap (g) can be from 0.1 μm to 1000 μm. If the gap is less than 0.1 μm then the electrode can be shorted. If the gap is more than 1000 μm then the footprint of the probe may be too large. Neural probes tend to prioritize a smaller footprint.

The thickness of the thin film in the conductive wall as measured from a sidewall of the insulator layer can be from 1 nm to 1 μm. In an instance, the thin film extends over a top of the wall by a length from 1 nm to 1 μm. The thickness of the conductive wall may be relatively uniform.

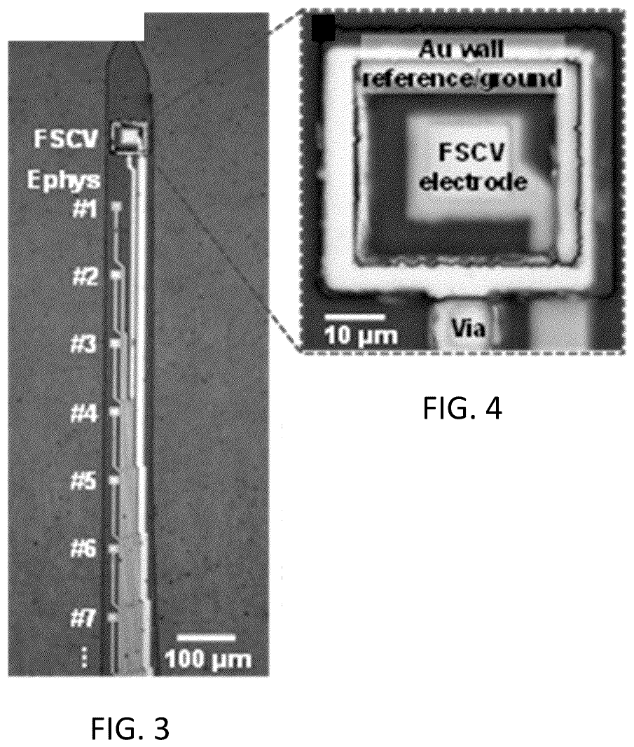

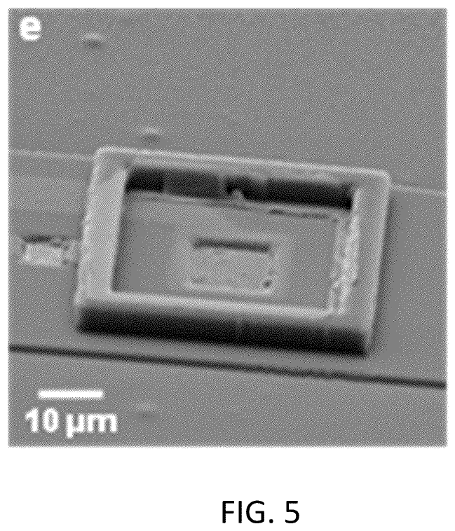

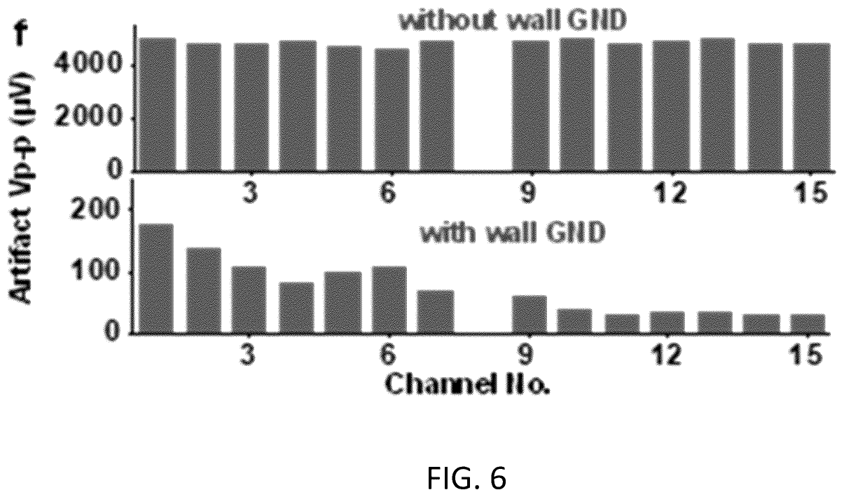

A preliminary locally grounded FSCV electrode was fabricated with a gold 3D wall (h=4.5 μm, g=10 μm), as shown in FIG. 3-5. Concurrent FSCV and ephys recording revealed that the peak FSCV-induced artifacts decreased from approximately 5 mVₚ₋ₚ with the gold wall floated to less than 180 μVₚ₋ₚ when the gold wall was connected to reference/ground (FIG. 6). For electrodes #11-15, the artifacts were even less than 25 μVₚ₋ₚ. The reduced artifact is still higher than the simulation, likely due to the high impedance from the gold wall. Nevertheless, the reduction of FSCV artifacts by 28 to 200 times demonstrates a promising current-enclosing effect from the local, 3D reference/ground design. Devices can be simulated/fabricated with different h, g, Z_{ref}, and a to optimize the effects.

While gold is disclosed for the 3D wall, platinum, silver, AgCl, IrOₓ, PEDOT:PSS, other metals, other metal alloys, or combinations thereof can be used.

In an instance, only the FSCV electrode includes a 3D conductive wall.

### Example 2

In another example of the embodiment of FIG. 1, a 3D conductive wall surrounds the CCM such that it can physically enclose the FSCV volume conduction and reduce the FSCV-induced artifacts. Synergistically, the 3D conductive wall can be fabricated (FIGS. 1 and 7-9) using the microfabrication-compatible FSCC process. The microfabrication FSCC process can include lithography, deposition, and etching steps.

A conductive wall ground design around the electrode can effectively localize the currents from FSCV and physically prevent its artifact to electrical recording to below 4 μVrms. Current localization can be enabled by having the current sink close to the current source and have no electrical-recording electrodes between. The materials, heights, proximity to the FSCV electrodes, and impedance of the 3D conductive wall ground can affect the reduction of FSCV artifacts. Generally, the higher the height, the closer the electrodes, and the lower the impedance of the 3D conductive wall, the stronger the effects tend to be. These parameters also can affect sensitivity, selectivity, electrochemical stability, and anti-fouling ability.

FEA with a volume conduction model was performed to simulate the FSCV artifact and investigate the effects of this design with different reference/ground height (h), gap (g), impedance (Zref), and FSCV electrode dimension (a). Preliminary FEA results revealed how the FSCV capacitive current conducts in the volume with and without the conductive wall ground design. Assuming FSCV generates an approximately 0.5 A/cm² peak current density into the recording environment, the simulated potential at the ephys electrode (100 μm away from the FSCV electrode) decreased from 1.7 mVₚ₋ₚ to approximately 8 μVₚ₋ₚ (2.8 μVrms) with a conductive wall ground (h=5 μm, g=10 μm).

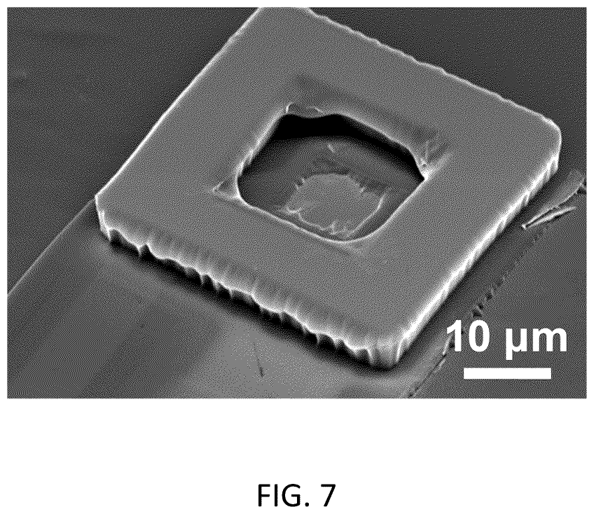

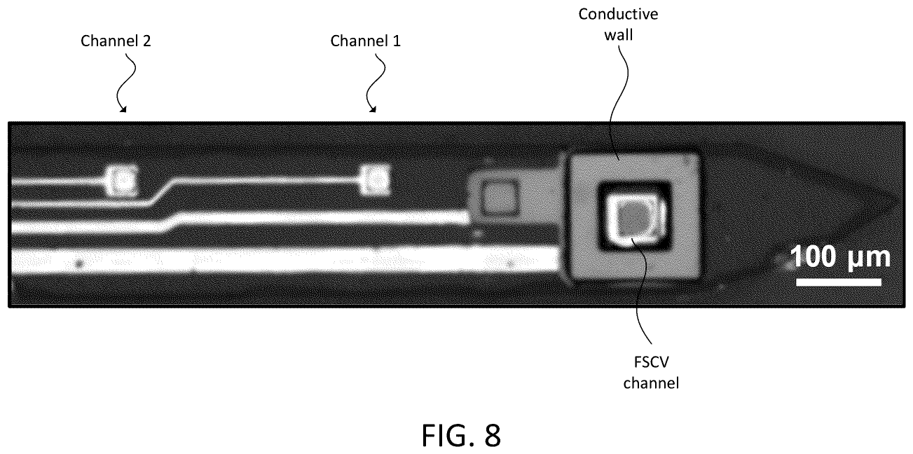

An embodiment disclosed herein can be used as the testing platform because its wall can be used to test the conductive wall effect on artifact prevention spatially across different recording electrodes with varying proximity. The 3D conductive wall was initially realized on a SU-8 frame around the FSCV electrode, with conductive and electrochemical coatings (FIG. 1). If a low-impedance ground is desired, the conductive wall can be sputter-coated with Ti/Au and then coated with PEDOT:PSS through electroplating. If a local reference is desired, the conductive wall can be sputter-coated with Ti/Ag and then achieve a stable Ag/AgCl surface from Ag by electroplating in 0.9% NaCl for enhanced voltage stability. The conductive wall can receive an optional NAFION coating together with the center electrode for minimized reference polarization in vivo. The conductive wall can connect through vias (FIG. 8) to a connection pad. The vias can be filled with gold, platinum, or other thin film metal materials. A preliminary demonstration of an ephys-FSCV MEA probe design with a working 3D conductive wall (h=4.5 μm, g=10 μm) coated with Au/PEDOT:PSS (e.g., total thickness of 0.3 μm) validated this fabrication process, as shown in FIG. 7 and FIG. 8.

In FIG. 8, the Au/PEDOT:PSS conductive wall surrounds the FSCV channel. Ephys channel 1 is closest to the conductive wall. Ephys channel 2 also is illustrated.

While SU-8 is disclosed, other dielectric materials such as silicon dioxide or silicon nitride can be used.

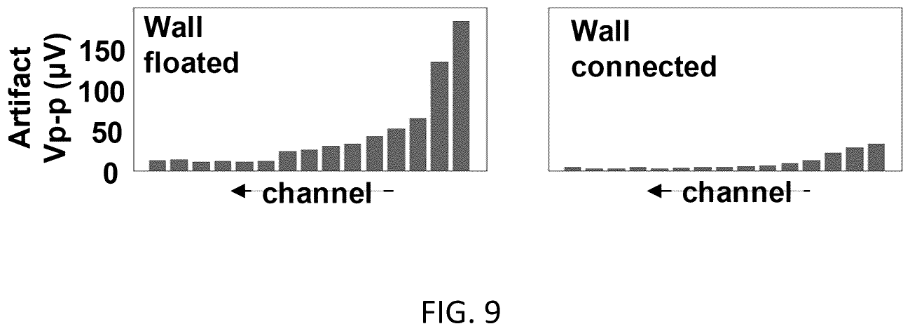

The conductive wall effectiveness was first tested without FSCC on Au microelectrodes using a reduced voltage window (e.g., from −0.4 V to 0.6 V). Then electrodes were tested with the full voltage window. The reduced voltage window avoided any redox reactions on the Au surface and maintained its integrity, but still induced predictable volume conduction. Concurrent FSCV and electrical recording was performed to examine FSCV-induced artifacts on recording. Preliminary result from this probe design demonstrated effective FSCV artifact prevention on recording microelectrodes (1 kHz-impedance, approximately 200 kΩ), especially nearby channels, as seen in FIG. 9. For example, in ephys channel 1 (200 μm from the FSCV electrode), the artifact has decreased from approximately 180 μVₚ₋ₚ to less than 30 μVₚ₋ₚ.

In an instance, FSCC is performed early in the MEA fabrication and a thin SU-8 layer (e.g., thickness 0.5 μm) is used to encapsulate it before moving to the conductive wall build-out. In another instance, a lift-off process within the conductive wall can be performed to achieve the FSCC. Results of 100-ch carbon-coated MEA were fabricated from successful lift-off.

To evaluate the reliability of the conductive wall design, tests were performed to evaluate its long-term performance on artifact prevention and FSCV sensing.

After bench testing and considering both artifact prevention and FSCV sensing preservation, the conductive wall design was examined in vivo. An anesthetized rat testing protocol was performed. Instead of using electrical stimulation, which will induce stimulation artifacts and complicate the studies, neuromodulator-stimulating drugs (e.g., 10 mg/kg amphetamine) were used to evoke DA. DA sensing was performed using 10 rats (half of each sex). The ephys data from anesthetized rats with running FSCV in parallel was recorded and the artifact prevention efficacy from different designs was determined in vivo.

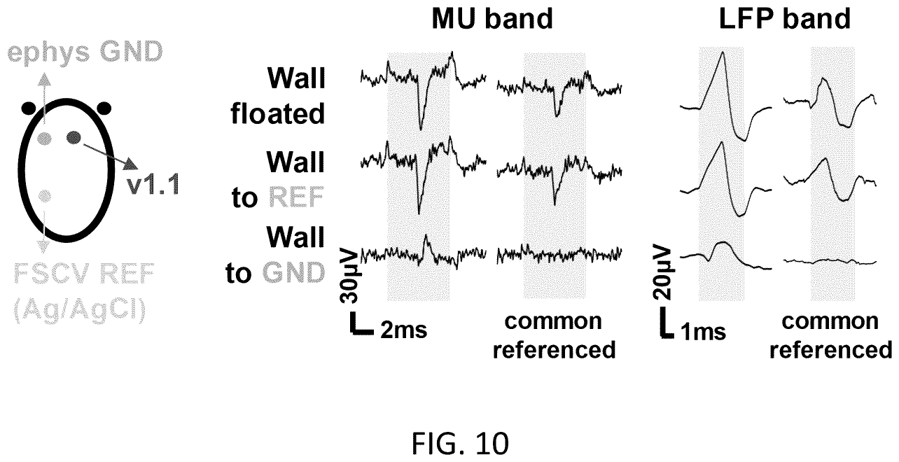

The connection options include FSCV potentiostat reference/ground (e.g., shorted in FSCV), ephys data acquisition ground, and being floated. Preliminary in vivo results show that, surprisingly, the conductive wall is most effective when it is connected with the ephys data acquisition ground but not the FSCV Ag/AgCl reference/ground, as shown in FIG. 10. Common referencing further led to artifact-free recording in both the multi-unit (MU) and LFP bands in FIG. 10. In the meantime, the FSCV background current shows similar behaviors regardless of how the conductive wall is connected. Note that for the in vivo testing results in FIG. 10, the ephys channel 3 was 600 μm away from the FSCV channel. In FIG. 10, v1.1 refers to an ephys-FSCV MEA probe design.

FIG. 10 includes the artifact waveforms in the wall-floated example. These artifact waveforms can negatively impact the analysis and interpretation of the electrical recording results. In extreme cases, interpretation will be impossible due to the artifacts.

Although the present disclosure has been described with respect to one or more particular embodiments, it will be understood that other embodiments of the present disclosure may be made without departing from the scope of the present disclosure. Hence, the present disclosure is deemed limited only by the appended claims and the reasonable interpretation thereof.

What is claimed is:

1. A system comprising:
a probe;
a fast scanning cyclic voltammetry electrode disposed on the probe;
a conductive wall disposed around the fast-scanning cyclic voltammetry electrode, wherein the conductive wall is disposed on the probe, and wherein the conductive wall is grounded; and
a wire in electronic communication with the fast-scanning cyclic voltammetry electrode, and wherein the wire is disposed on the probe.

2. The system of claim 1, wherein fast scanning cyclic voltammetry electrode currents are enclosed within the conductive wall.

3. The system of claim 1, wherein the conductive wall has a height from 1 μm to 100 μm and defines a gap between the conductive wall and an outer edge of the fast-scanning cyclic voltammetry electrode from 0.1 μm to 1000 μm.

4. The system of claim 3, wherein the height is from 1 μm to 10 μm.

5. The system of claim 3, wherein the gap is from 1 μm to 20 μm.

6. The system of claim 1, wherein the fast-scanning cyclic voltammetry electrode is fabricated of Ti/Au.

7. The system of claim 1, further comprising a carbon coating disposed on the fast-scanning cyclic voltammetry electrode.

8. The system of claim 1, wherein the conductive wall is disposed on an insulator layer that extends around the fast-scanning cyclic voltammetry electrode.

9. The system of claim 8, wherein the insulator layer includes photoresist, silicon dioxide, or silicon nitride.

10. The system of claim 8, wherein the wire extends through the insulator layer.

11. The system of claim 8, wherein the wire extends under the insulator layer.

12. The system of claim 1, wherein the conductive wall is fabricated of a material that includes gold, platinum, silver, AgCl, IrOₓ, or PEDOT:PSS.

13. The system of claim 1, wherein the conductive wall extends upward from a surface of the probe to fully encircle the fast-scanning cyclic voltammetry electrode, and wherein the fast-scanning cyclic voltammetry electrode is exposed through an aperture in a center of the conductive wall.

14. A method comprising:
performing a neural electroanalytical technique using a probe with an electrode and a conductive wall disposed around the electrode, wherein the conductive wall is connected to ground.

15. The method of claim 14, wherein electrode currents are enclosed within the conductive wall.

16. The method of claim 14, wherein the electroanalytical technique is fast scanning cyclic voltammetry, squarewave voltammetry, or differential pulse voltammetry.

17. The method of claim 14, wherein the electroanalytical technique is fast scanning cyclic voltammetry configured to have less than 180 μVₚ₋ₚ.

18. The method of claim 14, wherein the electroanalytical technique is fast scanning cyclic voltammetry, and the fast-scanning cyclic voltammetry is configured to have sub-μV level artifacts using the electrode.

19. The method of claim 14, wherein the electroanalytical technique is fast scanning cyclic voltammetry, and the fast-scanning cyclic voltammetry is configured to be artifact-free using the electrode.

20. The method of claim 14, wherein the conductive wall is fabricated of a material that includes gold, platinum, silver, AgCl, IrOₓ, or PEDOT:PSS.
